(19) United States
(12) Patent Application Publication
(10) Pub. No.: US 2025/0259790 A1
(43) Pub. Date: Aug. 14, 2025

(54) MULTILAYER CERAMIC CAPACITOR

(71) Applicant: Murata Manufacturing Co., Ltd., Nagaokakyo-shi (JP)

(72) Inventors: Naoto HIRATA, Nagaokakyo-shi (JP); Hiroyuki WADA, Nagaokakyo-shi (JP)

(21) Appl. No.: 19/171,464

(22) Filed: Apr. 7, 2025

Related U.S. Application Data
(63) Continuation of application No. PCT/JP2023/045072, filed on Dec. 15, 2023.

(30) Foreign Application Priority Data
Dec. 22, 2022 (JP) 2022-205327

(51) Int. Cl. H01G 4/12; C04B 35/468; H01G 4/008; H01G 4/232; H01G 4/30

(52) U.S. Cl. CPC H01G 4/1227; C04B 35/4682; H01G 4/008; H01G 4/232; H01G 4/30

(57) ABSTRACT

A multilayer ceramic capacitor includes an element body including dielectric ceramic layers and inner electrode layers, and outer electrodes on first and second end surfaces and electrically connected to the inner electrode layers. The dielectric ceramic layers include as a main component a crystal grain including perovskite composite oxide including barium and titanium and further including a rare-earth element. The dielectric ceramic layers include, in a section including a thickness direction, a rare-earth high-concentration region with an area ratio of about 50% or more having a molar ratio of the rare-earth element) to titanium of about 0.04 or more and about 0.30 or less, and in the section, a CV value of a thickness direction line segment ratio of the rare-earth high-concentration region is about 25% or less.

### CROSS REFERENCE TO RELATED APPLICATIONS

This application claims the benefit of priority to Japanese Patent Application No. 2022-205327 filed on Dec. 22, 2022 and is a Continuation Application of PCT Application No. PCT/JP2023/045072 filed on Dec. 15, 2023. The entire contents of each application are hereby incorporated herein by reference.

### BACKGROUND OF THE INVENTION

### 1. Field of the Invention

The present invention relates to multilayer ceramic capacitors.

### 2. Description of the Related Art

With the reduction in size of electronic devices such as mobile phones and the increase in CPU speed, the demand for multilayer ceramic capacitors (MLCC) has been increasing. Multilayer ceramic capacitors have a structure in which dielectric layers and inner electrode layers are alternately laminated and have, despite the reduced size, a large electrostatic capacitance resulting from the thinned high dielectric constant dielectric layers. Among known multilayer ceramic capacitors using various materials, those using a barium titanate (BaTiO₃) based compound for dielectric layers and a non-precious metal such as nickel (Ni) for inner electrode layers are widely used because they are inexpensive and have preferable characteristics.

In order to achieve miniaturization and increases in the capacitance of a multilayer ceramic capacitor, thinning of the dielectric layer is important. However, when the dielectric layer is made thinner, an insulation resistance lifetime between the inner electrode layers is shortened, which leads to a problem of a decrease in reliability. In order to solve the problem above, a technique has been proposed in which additives such as a rare-earth element (RE) and magnesium (Mg) are added to a dielectric layer made of a BaTiO₃ based compound to extend the insulation resistance lifetime and increase the reliability.

For example, Japanese Patent No. 3334607 discloses a dielectric ceramic composite including main components represented by a specific composition formula (e.g., see claim 1 of Japanese Patent No. 3334607). The main components are made of barium titanate, at least one of europium oxide, gadolinium oxide, terbium oxide, dysprosium oxide, holmium oxide, erbium oxide, thulium oxide, and ytterbium oxide, barium zirconate, magnesium oxide, and manganese oxide. Further, Japanese Patent No. 3334607 describes an application of the ceramic composite to a dielectric ceramic layer of a multilayer ceramic capacitor having an inner electrode made of nickel or a nickel alloy, and describes, when the multilayer ceramic capacitor is used in a high electric field strength, a large product of insulation resistance and electrostatic capacitance (CR product), high insulation strength, and high environmental resistance performance such as high temperature load resistance or moisture load resistance is obtained (e.g., see claim 4 and [0007] of Japanese Patent No. 3334607).

With the progress of electronic components and electronic devices, further miniaturization and increased capacitance of multilayer ceramic capacitors are expected. As the use of the multilayer ceramic capacitor is expanded, the demand for an increase in reliability is increasing. Thus, a multilayer ceramic capacitor is desired in which, while being thinned further, insulation properties are preferable and reliability is excellent with less deterioration even under high temperature and high humidity. However, although the technique proposed in the related art has a certain effect, there is still room for improvement.

The inventors of example embodiments of the present invention have conducted intensive studies in view of the above problems. As a result, the inventors have discovered that the reliability of the multilayer ceramic capacitor can be markedly improved by controlling a region including a rare-earth element in the dielectric ceramic layer.

### SUMMARY OF THE INVENTION

Example embodiments of the present invention provide multilayer ceramic capacitors each with excellent reliability.

In the present description, the expression “to” includes numerical values at both ends. That is, “X to Y” is synonymous with “X or more and Y or less”.

According to an example embodiment of the present invention, a multilayer ceramic capacitor includes a first main surface and a second main surface opposed to each other in a thickness direction, a first side surface and a second side surface opposed to each other in a width direction, and a first end surface and a second end surface opposed to each other in a length direction. The multilayer ceramic capacitor includes an element body including dielectric ceramic layers and inner electrode layers laminated in the thickness direction, and a pair of outer electrodes on the first end surface and the second end surface and electrically connected to the inner electrode layers. The dielectric ceramic layers include, as a main component, a crystal grain including perovskite composite oxide including barium (Ba) and titanium (Ti) and further including a rare-earth element (Re). The dielectric ceramic layers include, in a section including the thickness direction, a rare-earth high-concentration region with an area ratio of about 50% or more and having a molar ratio of the rare-earth element (Re) to titanium (Ti) (Re/Ti ratio) of about 0.04 or more and about 0.30 or less, and, in the section, a CV value of a thickness direction line segment ratio of the rare-earth high-concentration region is about 25% or less.

According to example embodiments of the present invention, multilayer ceramic capacitors each with excellent reliability are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating an outer shape of a multilayer ceramic capacitor according to an example embodiment of the present invention.

FIG. 2 is a sectional view schematically illustrating an internal structure of a multilayer ceramic capacitor according to an example embodiment of the present invention.

FIG. 3 is a sectional view schematically illustrating an internal structure of a multilayer ceramic capacitor according to an example embodiment of the present invention.

FIGS. 4A and 4B are diagrams for describing a thickness direction line segment ratio of a rare-earth high-concentration region and a CV value thereof.

FIGS. 5A and 5B are schematic sectional views illustrating a microstructure of a multilayer ceramic capacitor according to an example embodiment of the present invention.

### DETAILED DESCRIPTION OF THE EXAMPLE EMBODIMENTS

Example embodiments of the present invention will be described in detail with reference to the drawings. The present invention is not limited to the following example embodiments, and various modifications can be made without departing from the scope of the present invention.

### 1. Multilayer Ceramic Capacitor

A multilayer ceramic capacitor according to an example embodiment of the present invention includes a first main surface and a second main surface opposed to each other in a thickness direction, a first side surface and a second side surface opposed to each other in a width direction, and a first end surface and a second end surface opposed to each other in a length direction. The multilayer ceramic capacitor includes an element body including dielectric ceramic layers and inner electrode layers laminated in the thickness direction and a pair of outer electrodes provided on the first end surface and the second end surface and electrically connected to the inner electrode layers. The dielectric ceramic layers include as a main component a crystal grain including perovskite composite oxide including barium (Ba) and titanium (Ti) and further including a rare-earth element (Re). The dielectric ceramic layers include, in a section including the thickness direction, a rare-earth high-concentration region with an area ratio of about 50% or more having a molar ratio of the rare-earth element (Re) to titanium (Ti) (Re/Ti ratio) of about 0.04 or more and about 0.30 or less. In the section, a CV value of a thickness direction line segment ratio of the rare-earth high-concentration region is about 25% or less.

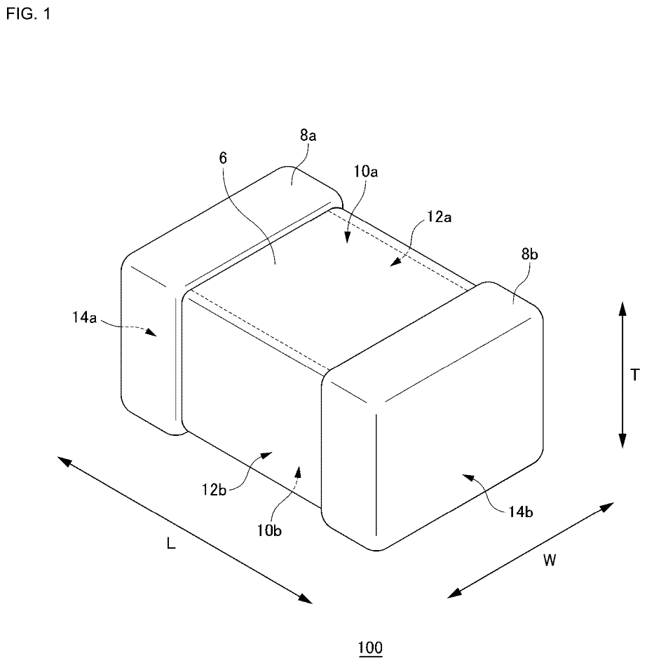

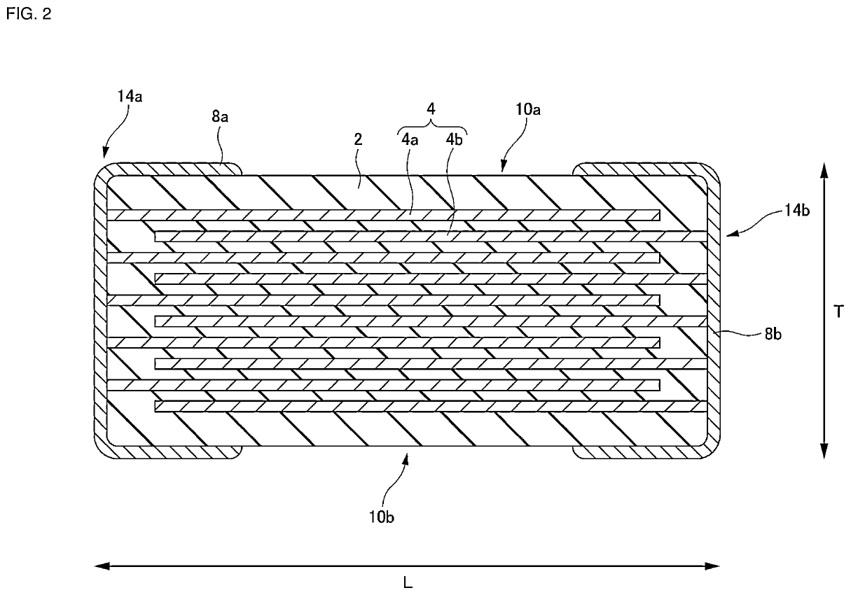

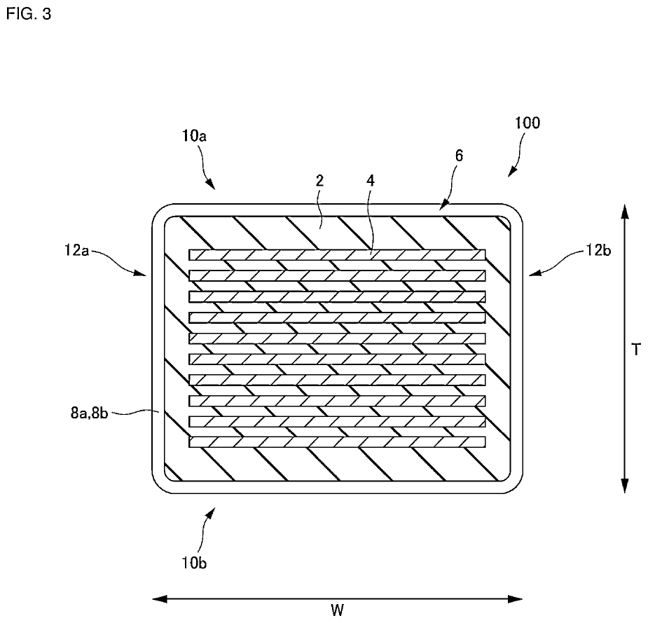

A multilayer ceramic capacitor according to an example embodiment of the present invention will be described with reference to FIG. 1 to FIG. 3. FIG. 1 is a perspective view illustrating an outer shape of the multilayer ceramic capacitor. FIG. 2 and FIG. 3 are sectional views illustrating the inside of the multilayer ceramic capacitor. A multilayer ceramic capacitor (100) includes an element body (6) including laminated dielectric ceramic layers (2) and inner electrode layers (4), and a pair of outer electrodes (8a and 8b) provided on both end surfaces (14a and 14b) of the element body (6). The multilayer ceramic capacitor (100) and the element body (6) each have a rectangular or substantially rectangular parallelepiped shape. The rectangular or substantially rectangular parallelepiped shape includes not only a rectangular parallelepiped but also a rectangular parallelepiped shape including rounded corners and/or ridges. The multilayer ceramic capacitor (100) and the element body (6) each include a first main surface (10a) and a second main surface (10b) opposed to each other in a thickness direction T, a first side surface (12a) and a second side surface (12b) opposed to each other in a width direction W, and a first end surface (14a) and a second end surface (14b) opposed to each other in a length direction L. The thickness direction T refers to the direction in which the dielectric ceramic layers (2) and the inner electrode layers (4) are laminated. The length direction L refers to a direction that is orthogonal or substantially orthogonal to the thickness direction T and also orthogonal or substantially orthogonal to the end surfaces (14a and 14b) provided with the outer electrodes (8a and 8b). The width direction W is a direction orthogonal or substantially orthogonal to the thickness direction T and the length direction L. A plane including the thickness direction T and the width direction W is defined as a WT plane, a plane including the width direction W and the length direction L is defined as an LW plane, and a plane including the length direction L and the thickness direction T is defined as an LT plane.

The outer electrodes (8a and 8b) include the first outer electrode (8a) provided on the first end surface (14a) and the second outer electrode (8b) provided on the second end surface (14b). The first outer electrode (8a) may extend to a portion of each of the first main surface (10a), the second main surface (10b), the first side surface (12a), and the second side surface (12b). The second outer electrode (8b) may extend to a portion of each of the first main surface (10a), the second main surface (10b), the first side surface (12a), and the second side surface (12b). However, the first outer electrode (8a) and the second outer electrode (8b) are not in contact with each other and are electrically separated from each other.

The inner electrode layer (4) includes first inner electrode layers (4a) and second inner electrode layers (4b). The first inner electrode layers (4a) extend to the first end surface (14a) and are electrically connected to the first outer electrode (8a). The second inner electrode layers (4b) extend to the second end surface (14b) and are electrically connected to the second outer electrode (8b). The first inner electrode layer (4a) and the second inner electrode layer (4b) facing each other with the dielectric ceramic layer (2) interposed therebetween are not electrically connected to each other. Thus, when a voltage is applied between the first inner electrode layer (4a) and the second inner electrode layer (4b) via the outer electrodes (8a and 8b), electric charges are accumulated. The accumulated electric charges generate electrostatic capacitance, thus defining and functioning as a capacitance element.

The size of the multilayer ceramic capacitor (100) is not particularly limited. However, for example, it is preferable that a dimension in the length direction L is about 0.4 mm or more and about 5.7 mm or less, a dimension in the width direction W is about 0.2 mm or more and about 5.0 mm or less, and a dimension in the lamination direction T is about 0.125 mm or more and about 5.0 mm or less.

### Dielectric Ceramic Layer

The dielectric ceramic layer is made of ceramic. The dielectric ceramic layer includes, for example, as a main component a crystal grain including perovskite composite oxide including barium (Ba) and titanium (Ti). That is, for example, the main crystal grain includes the perovskite composite oxide. The main crystal grain is made of a barium titanate (BaTiO₃) based compound, for example. Accordingly, it can be said that the dielectric ceramic layer is made of a sintered body of a BaTiO₃ based compound. BaTiO₃ is a perovskite oxide represented by a general formula ABO₃. BaTiO₃ has a tetragonal crystal structure at room temperature and is a strong dielectric that has a high dielectric constant. By using a BaTiO₃ based compound as a main component, the dielectric constant of the dielectric ceramic can be increased, and the capacitance of a capacitor can be increased. In the present description, the main component is a component having the highest content in the ceramic. The content of the main component may be, for example, about 50 mass % or more, about 60 mass % or more, about 70 mass % or more, about 80 mass % or more, or about 90 mass % or more.

The barium titanate (BaTiO₃) based compound is not particularly limited as long as it is a perovskite composite oxide mainly including barium (Ba) and titanium (Ti). That is, for example, this compound may be BaTiO₃, or may be a compound in which a portion of Ba and/or Ti included in BaTiO₃ is substituted by other elements. Specifically, for example, a portion of barium (Ba) may be substituted by other elements such as strontium (Sr) and calcium (Ca), and a portion of titanium (Ti) may be substituted by other elements such as zirconium (Zr) and hafnium (Hf). Further, the ratio between an A-site element (Ba, Sr, Ca, or the like) and a B-site element (Ti, Zr, Hf, or the like) of the BaTiO₃ based compound is not strictly limited to 1:1. As long as the perovskite crystal structure is maintained, a deviation in the ratio of the A-site element and the B-site element is allowed.

The dielectric ceramic layer further includes a rare-earth element (Re) in addition to barium (Ba) and titanium (Ti). The rare-earth element (Re) is, in the periodic table, a general term for elements in the group of scandium (Sc) of atomic number 21, yttrium (Y) of atomic number 39, and lanthanum (La) of atomic number 57 to lutetium (Lu) of atomic number 71. The dielectric ceramic layer may include one type of rare-earth element or a combination of multiple types of rare-earth elements. The rare-earth element may be included only in the BaTiO₃ based compound being the main crystal grain, or may be included, in addition to being included in the main crystal grain, in a grain boundary or a triple point. When the rare-earth element is included in the main crystal grain, the rare-earth element may occupy a Ba-site (A-site) of the BaTiO₃ based compound, a Ti-site (B-site) thereof, or both sites thereof.

By adding a rare-earth element (Re) to the dielectric ceramic layer, various characteristics of the multilayer ceramic capacitor such as reliability and temperature characteristics of the dielectric constant can be improved. That is, the BaTiO₃ based compound being the main component may include many oxygen porosities generated in a firing process. The oxygen porosities are more likely to decrease the insulation resistance when accompanied by electron compensation and are more likely to cause a decrease in the insulation resistance over time by moving under an electric field. When a rare-earth element is added to the dielectric ceramic layer, the rare-earth element tends to be solid-solved in the Ba-site or the Ti-site of the BaTiO₃ based compound. The rare-earth element in solid solution acts as a donor or an acceptor and reduces or prevents the movement of oxygen porosities or mitigates the generation of a conduction electron. Consequently, the deterioration of the insulation resistance is reduced or prevented, and a high temperature load lifetime is increased. The BaTiO₃ based compound has a large temperature dependency in the dielectric constant in the vicinity of Curie temperature Tc. By providing a solid solution with a rare-earth element, the change in the dielectric constant depending on temperature can be flattened in a wide range including the Curie temperature Tc.

The type of the rare-earth element (Re) included in the dielectric ceramic layer is not particularly limited. However, for example, it is preferable to include at least one of yttrium (Y), lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), or lutetium (Lu), and it is particularly preferable to include, for example, dysprosium (Dy). Dy is an element positioned in approximately the middle of the lanthanoid group in the periodic table, and the ionic radius thereof is also approximately medium in length. Consequently, Dy can be solid-solved in both the Ba-site (A-site) and the Ti-site (B-site) of the BaTiO₃ based compound, which is effective in increasing reliability. For example, the dielectric ceramic layer may include only Dy as the rare-earth element, or may include other rare-earth elements together with Dy.

By adding a suitable amount of rare-earth element (Re) to the dielectric ceramic layer, the advantageous effect of improving various characteristics can be more markedly provided. The dielectric ceramic layer preferably includes, for example, in proportion to titanium (Ti) of 100 mol, the rare-earth element (Re) of about 0.1 mol or more and about 35.0 mol or less, more preferably about 0.5 mol or more and about 30.0 mol or less, and still more preferably about 3.5 mol or more and about 25.0 mol or less. The molar numbers above are the molar numbers as a raw material.

The dielectric ceramic layer may include an additive component other than the rare-earth element (Re). Such components include, for example, manganese (Mn), magnesium (Mg), silicon (Si), aluminum (Al), vanadium (V), lithium (Li), boron (B), copper (Cu), and/or molybdenum (Mo). The form of the additive component is not limited. It is sufficient that such a component is included in any of the main crystal grain, the grain boundary, and the triple point.

Preferably, for example, the dielectric ceramic layer has a thickness of about 0.5 μm or more and about 7.0 μm or less. By setting the thickness of the dielectric ceramic layer to be about 0.5 μm or more, deterioration of the insulation properties can be reduced or prevented, which leads to an increase in reliability. On the other hand, when the thickness is about 7.0 μm or less, the dielectric ceramic layer is thinned, and the capacitance can be increased. The number of dielectric ceramic layers is, for example, preferably 50 or more and 1000 or less.

In the multilayer ceramic capacitor of the present example embodiment, the dielectric ceramic layer includes, in a section including the thickness direction, the rare-earth high-concentration region with the area ratio of about 50% or more, for example. Here, the thickness direction is the lamination direction of the dielectric ceramic layers and the inner electrode layers. Accordingly, the section including the thickness direction is a plane passing through the inside of the multilayer ceramic capacitor, that is, a plane whose perpendicular line is orthogonal or substantially orthogonal to the thickness direction, and is the LT plane or the WT plane, for example. The rare-earth high-concentration region is a region in which the molar ratio of the rare-earth element (Re) to titanium (Ti) (Re/Ti ratio) is, for example, about 0.04 or more and about 0.30 or less. That is, for example, when the section of the dielectric ceramic layer is classified into a rare-earth ultra-high-concentration region of an Re/Ti ratio of more than about 0.30, a rare-earth high-concentration region of an Re/Ti ratio of about 0.04 or more and about 0.30 or less, and a rare-earth low-concentration region of an Re/Ti ratio of less than about 0.04, a ratio of an area occupied by the high-concentration region to a total area of the rare-earth ultra-high-concentration region, the rare-earth high-concentration region, and the rare-earth low-concentration region is about 50% or more.

By increasing the area ratio of the rare-earth high-concentration region to about 50% or more, the reliability of the multilayer ceramic capacitor can be more markedly increased. The detailed reason is not clear but is presumed as follows. High concentration of a rare-earth means that the mean distance between positions where the rare-earth elements are present is short. The rare-earth element has an advantageous effect of reducing or preventing the movement of an oxygen porosity. By shortening the mean distance between the rare-earth elements, the advantageous effect of reducing or preventing the movement of the oxygen porosity increases, and as a result, reliability is increased. From the viewpoint of increasing the reliability, the area ratio of the rare-earth high-concentration region is preferably as high as possible. The area ratio may be, for example, about 55% or more, about 60% or more, about 65% or more, about 70% or more, about 75% or more, about 80% or more, about 85% or more, 90% or more, about 95% or more, or may be 100%. However, when the area ratio is excessively high, the dielectric constant may decrease. From the viewpoint of increasing the dielectric constant, the area ratio may be, for example, about 95% or less, about 90% or less, about 85% or less, about 80% or less, about 75% or less, about 70% or less, about 65% or less, or about 60% or less.

Preferably, for example, in the section including the thickness direction, the CV value of the Re/Ti ratio in the rare-earth high-concentration region is about 35% or less. The CV value is an index of variation. The smaller the CV value of the Re/Ti ratio is, the smaller the variation in the Re/Ti ratio at each location in the rare-earth high-concentration region is. By restricting the CV value of the Re/Ti ratio to about 35% or less, the variation in reliability can be reduced or prevented. The reason in detail is not clear but is presumed as follows. A large CV value, even with the Re/Ti ratio as a mean value being the same, may mean that there is a region where the Re/Ti ratio is extremely lower than the mean value, or that the total size of the dispersed low Re/Ti ratio regions is large. The low Re/Ti ratio region may decrease reliability. Accordingly, when the CV value of the Re/Ti ratio is small, the reliability variation can be made small in a sense that the reliability is less likely to be reduced. From the viewpoint of mitigating the variation in reliability, the CV value is preferably as small as possible. The CV value may be, for example, about 30% or less, about 25% or less, 20% or less, about 15% or less, or about 10% or less. The CV value of the Re/Ti ratio can be obtained as follows. The rare-earth high-concentration region is divided into minute regions, and the Re/Ti ratio of each region is measured by a technique such as transmission electron microscopy (TEM)—energy dispersive X-ray spectroscopy (EDX). The CV value of the Re/Ti ratio is obtained with the Equation (1) below using the mean value and standard deviation o of the Re/Ti ratios.

$$CV value of Re / Ti ratio ( \% ) = \frac{( σ of Re / Ti ratio )}{( Mean value of Re / Ti ratio )} \times 100 \qquad ( 1 )$$

The multilayer ceramic capacitor of the present example embodiment includes, in a section including the thickness direction, the CV value of the thickness direction line segment ratio of the rare-earth high-concentration region of about 25% or less. The thickness direction line segment ratio of the rare-earth high-concentration region refers to a ratio of a portion occupied by the rare-earth high-concentration region on one line extending in the thickness direction inside the dielectric ceramic layer. Thus, the CV value of the thickness direction line segment ratio is an index of a variation in a distribution of the rare-earth high-concentration region and other regions inside the dielectric ceramic layer.

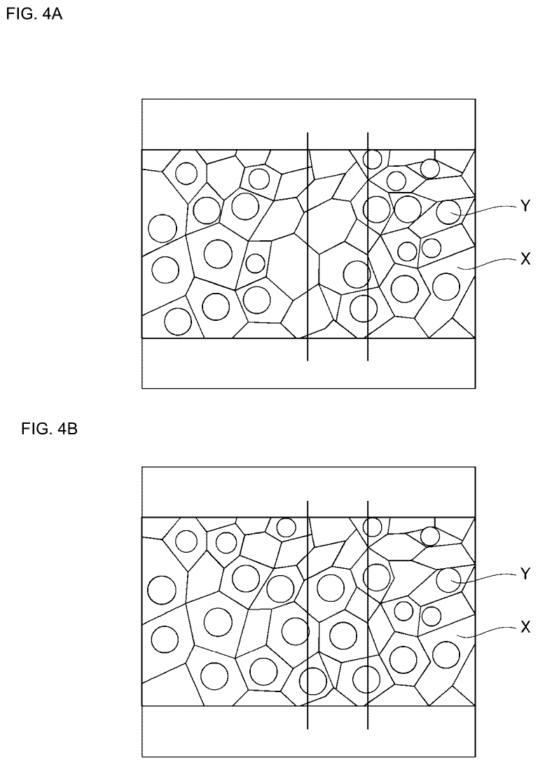

This will be described with reference to FIGS. 4A and 4B. FIGS. 4A and 4B each schematically illustrate a configuration in which the rare-earth low-concentration regions are interspersed in the rare-earth high-concentration regions in a section of the dielectric ceramic layer. When the rare-earth low-concentration regions (Y in the drawing) are distributed unevenly (FIG. 4A), the ratio of the portion occupied by the rare-earth high-concentration regions (X in the drawing) (thickness direction line segment ratio of the rare-earth high-concentration region) greatly varies from line to line in multiple lines extending in the thickness direction. As a result, the CV value of the thickness direction line segment ratio becomes large. In contrast, when the rare-earth low-concentration region is distributed relatively uniformly (FIG. 4B), the value of the thickness direction line segment ratio is constant or substantially constant among the lines. This causes the CV value of the thickness direction line segment ratio to be small.

By restricting the CV value of the thickness direction line segment ratio to about 25% or less, for example, the reliability can further be increased and the variation in reliability can be reduced or prevented. That is, a small CV value of the thickness direction line segment ratio means that the rare-earth high-concentration regions and other regions are more uniformly distributed in the ceramic layer. When such distribution is uniform, local electric field concentration is reduced, which leads to further increase in reliability. From the viewpoint of increasing reliability and lowering variation, the CV value of the thickness direction line segment ratio of the rare-earth high-concentration region is, for example, more preferably about 15% or less.

The CV value of the thickness direction line segment ratio of the rare-earth high-concentration region is obtained as follows. First, in a section including the thickness direction, virtual line parallel or substantially parallel to the thickness direction is drawn. Next, L_{C} that is a length of a portion through which the line crosses the dielectric ceramic layer is obtained. L_{C} can also be referred to as the length of a line segment on the line defined by the dielectric ceramic layer. Further, L_{high-Re} that is a total length of portions through which the line crosses the rare-earth high-concentration region is obtained. L_{high-Re} can also be referred to as the total length of line segments on the line defined by the rare-earth high-concentration region. Next, the ratio of L_{high-Re} to L_{C} (L_{high-Re}/L_{C}) is calculated as the thickness direction line segment ratio of the rare-earth high-concentration region. The thickness direction line segment ratio is calculated for multiple (for example, 256) lines that are spaced apart, and the CV value is obtained with the following Equation (2) using the mean value and the standard deviation o of the calculated thickness direction line segment ratios.

$$\begin{matrix}CV value of thickness \\ direction line segment ratio ( \% )\end{matrix} = \frac{\begin{matrix}( σ of thickness direction \\ line segment ratio )\end{matrix}}{\begin{matrix}( Mean value of thickness \\ direction line segment ratio )\end{matrix}} \times 100 \qquad ( 2 )$$

The reliability of the multilayer ceramic capacitor and the variation thereof can be evaluated by examining the high temperature load lifetime. The high temperature load lifetime can be evaluated by subjecting a capacitor to a high temperature load test and using a mean time to failure (MTTF) and a B1 life obtained therefrom. Specifically, the high temperature load test is performed on multiple capacitors, and the time when the insulation resistance drastically decreases is determined as the time to failure. The time to failure of each capacitor is subjected to Weibull analysis to obtain the time to failure at which a cumulative failure rate is about 63.2% and a shape parameter m, and the mean time to failure (MTTF) is determined using the values above. The time to failure at which the cumulative failure rate is about 1% is defined as the B1 life. Longer MTTF can be evaluated as higher reliability. Further, the larger the B1 life/MTTF is, the smaller the variation in reliability is evaluated.

The distribution of the rare-earth high-concentration region included in the dielectric ceramic layer is not particularly limited thereto. A configuration may be provided in which the dielectric ceramic layer has a sea-island structure in a section, and the rare-earth high-concentration regions and other regions define sea portions and island portions, respectively. Specifically, a configuration may be provided in which the rare-earth high-concentration region includes other regions, for example, rare-earth low-concentration regions being dispersed therein. Alternatively, the rare-earth high-concentration regions and other regions may extend in a layered manner, and each layer of the dielectric ceramic layers may have a laminated structure including the layered rare-earth high-concentration regions and other regions.

Preferably, in a section including the thickness direction, the dielectric ceramic layer includes a rare-earth low-concentration region, and the rare-earth low-concentration region is defined by multiple sub-regions surrounded by the high-concentration region. Preferably, the mean value of the equivalent circle diameters (mean equivalent circle diameter) of the respective sub-regions in the section is, for example, about 130 nm or more. That is, it is preferable that the dielectric ceramic layer has a sea-island structure in this section, the rare-earth high-concentration regions define sea portions, the rare-earth low-concentration regions define island portions, and the mean equivalent circle diameter of the island portion has a predetermined value or more. As described above, dispersing the rare-earth low-concentration regions having a desired size in the form of island in the rare-earth high-concentration regions, the dielectric constant can be increased while ensuring the reliability of the multilayer ceramic capacitor. The detailed reason is not clear but is presumed as follows. The Curie temperature Tc of the rare-earth high-concentration region may be lower than room temperature depending on the Re/Ti ratio, and the dielectric constant decreases in this case. However, the decrease in dielectric constant can be avoided by mixing the rare-earth low-concentration region having the Curie temperature Tc sufficiently higher than the room temperature. Further, since the dielectric constant is accompanied by a size effect, a higher dielectric constant can be obtained by increasing the mean equivalent circle diameter of the rare-earth low-concentration region to a predetermined value or more. From the viewpoint of increasing the dielectric constant, the size of each of the distributed sub-regions is preferably as large as possible. The mean equivalent circle diameter of the sub-regions may be, for example, about 140 nm or more, about 150 nm or more, about 160 nm or more, about 170 nm or more, about 180 nm or more, about 190 nm or more, about 200 nm or more, about 210 nm or more, or about 220 nm or more. On the other hand, in order to make the advantageous effect of increasing reliability more effectively provided, the size of the rare-earth low-concentration region is preferably restricted to a certain size. The mean equivalent circle diameter of the sub-regions may be, for example, about 300 nm or less, about 290 nm or less, about 280 nm or less, about 270 nm or less, about 260 nm or less, about 250 nm or less, about 240 nm or less, about 230 nm or less, about 220 nm or less, about 210 nm or less, about 200 nm or less, about 190 nm or less, about 180 nm or less, about 170 nm or less, or about 160 nm or less. The mean equivalent circle diameter (D50) is the diameter of a circle having the same area as a cumulative 50% area. With a total area of the sub-regions being defined as 100%, the cumulative 50% area is the total area of the sub-regions when areas of the sub-regions are integrated in ascending order to accumulate to about 50%. The mean equivalent circle diameter can be calculated with the following Equation (3) using the cumulative 50% area.

$$Average equivalent circle diameter = \sqrt{\frac{4}{π} \cdot ( Cumulative 50 \% area )} \qquad ( 3 )$$

Preferably, in a section including the thickness direction, the mean value of circularities (mean circularity) of the respective sub-regions defining the rare-earth low-concentration region is about 0.70 or more, for example. The circularity is an index indicating the complexity of a shape of a region, is 1 for a perfect circle, and decreases as the shape becomes more complex. By forming the shape of the dispersed rare-earth low-concentration region into a substantially circular shape, the voltage dependency of the high temperature load lifetime can be reduced or prevented. The detailed reason is not clear but is presumed as follows. By increasing the circularity of the sub-region defining the rare-earth low-concentration region, the probability of the presence of a portion having an extremely high curvature at a boundary with the rare-earth high-concentration region can be reduced. Because the insulation resistance varies depending on the rare-earth element concentration, it is considered that the insulation resistance varies greatly particularly at a boundary between the rare-earth low-concentration region and the rare-earth high-concentration region. Accordingly, the smoother the boundary is, that is, the higher the circularity of the sub-region defining the rare-earth low-concentration region is, the more the electric field concentration can be reduced or prevented, and as a result, the voltage dependency of the high temperature load lifetime becomes smaller. The mean circularity of the sub-regions may be, for example, about 0.75 or more, about 0.80 or more, or about 0.85 or more. The mean circularity can be obtained by calculating the mean value of the circularities, obtained with the following Equation (4) using an area and a perimeter of each sub-region taken by TEM observation or the like.

$$Circularity = \frac{4 π \times ( Area )}{{( Perimeter )}^{2}} \qquad ( 4 )$$

### Inner Electrode Layer

The inner electrode layer includes a conductive metal. As the conductive metal, a known electrode material such, for example, nickel (Ni), copper (Cu), silver (Ag), palladium (Pd), or an alloy thereof may be used. The inner electrode layer may include a component other than the conductive metal. Other components include a ceramic component which defines and functions as a co-material. Examples of the ceramic component include a BaTiO₃ based compound included in the dielectric ceramic layer.

Preferably, the thickness of the inner electrode layer is, for example, about 0.3 μm or more and about 0.7 μm or less. By setting the thickness of the inner electrode layer to about 0.3 μm or more, defects such as electrode disconnection are reduced or prevented. Further, by setting the thickness of the inner electrode layer to about 0.7 μm or less, a decrease in the ratio of the dielectric ceramic layer that electrically defines and functions in the capacitor and a decrease in capacitance due to the decrease in the ratio can be reduced or prevented.

### Outer Electrode

A known configuration can be provided as the outer electrode. For example, the outer electrode may have a multilayer structure including a base layer, a first plating layer, and a second plating layer in this order from the end surface side of the multilayer ceramic capacitor. The base layer includes a metal such as, for example, nickel (Ni) or copper (Cu). A ceramic powder may be included as a co-material in addition to the metal. The first plating layer is, for example, a nickel (Ni) plating layer. The second plating layer is, for example, a tin (Sn) plating layer. A conductive resin layer may be provided between the base layer and the first plating layer. The conductive resin layer is a layer including a conductive metal particle such as, for example, copper (Cu), silver (Ag), or nickel (Ni), and a resin. A configuration of the outer electrode is not limited as long as it is electrically connected to the inner electrode layer and defines and functions as an outer input/output terminal.

### 2. Method for Manufacturing Multilayer Ceramic Capacitor

The method for manufacturing the multilayer ceramic capacitor of the present example embodiment is not limited as long as the above-described requirements are satisfied. An example of a manufacturing method according to an example embodiment of the present invention includes a process of fabricating a green sheet including at least barium (Ba), titanium (Ti), and a rare-earth element (Re) (green sheet fabrication process), a process of applying a conductive paste to a surface of the green sheet to obtain a green sheet including an inner electrode pattern formed thereon (electrode pattern forming process), a process of laminating and pressure bonding multiple green sheets to obtain a multilayer block (lamination process), a process of cutting the multilayer block to obtain a multilayer chip (cutting process), a process of a binder removal treatment and a firing treatment of the multilayer chip to obtain an element body (firing process), and a process of forming outer electrodes on the obtained element body (outer electrode forming process). Details of each process will be described below.

### Green Sheet Fabrication Process

In the green sheet fabrication process, a green sheet including at least barium (Ba), titanium (Ti), and a rare-earth element (Re) is fabricated. The green sheet is a precursor of the dielectric ceramic layer of a capacitor and includes a main component raw material and an additive raw material of the dielectric ceramic layer. The green sheet may be fabricated by a known method, and the method is not particularly limited. The dielectric raw material is fabricated by mixing the additive raw material to the main component raw material, the binder and the solvent are added and mixed to the obtained dielectric raw material to make slurry, and the green sheet is formed from the obtained slurry.

A powder of a BaTiO₃ based compound is used as the main component raw material. The BaTiO₃ based compound may be synthesized using known ceramic raw materials such as, for example, oxide, carbonate, hydroxide, nitrate, organic acid salt, alkoxide, and/or a chelate compound with known ceramic synthesis methods such as, for example, a solid-phase reaction method, a hydrothermal synthesis method, and an alkoxide method. The additive raw material includes at least a rare-earth element (Re) raw material. As the Re raw material, a known ceramic raw material such as, for example, oxide, carbonate, hydroxide, nitrate, organic acid salt, alkoxide, and/or chelate compound of Re may be used. The additive raw materials may include a raw material of other additive components such as, for example, Mn, Mg, Si, Al, V, Li, B, Cu, and/or Mo. In order to control the composition of the BaTiO₃ based compound being the main component, a Ba raw material or a Ti raw material such as, for example, barium carbonate (BaCO₃) or titanium dioxide (TiO₂) may be added to the additive raw material.

The raw materials may be mixed by a known method, and examples of the known method include a method of mixing and pulverizing a weighed main component raw material, additive raw material, and water together with a pulverization medium, in a wet process using a ball mill. When the mixing is performed in a wet process, the obtained mixture may be dried. If necessary, the dielectric raw material obtained after drying may be calcined. The slurry may be made with a known method, and an organic binder and an organic solvent may be mixed with the dielectric raw material. As the organic binder, a known binder such as, for example, a polyvinyl butyral based binder may be used. As the organic solvent, a known solvent such as, for example, toluene or ethanol may be used. Additives such as, for example, plasticizers may be added to the slurry as needed. Further, the green sheet may be formed with a known method such as, for example, a doctor blade method or a lip method.

### Electrode Pattern Forming Process

In the electrode pattern forming process, a conductive paste is applied to the surface of the green sheet to obtain a green sheet including an inner electrode pattern formed thereon. The inner electrode pattern becomes an inner electrode layer after firing. As the conductive metal included in the conductive paste, a conductive material such as, for example, nickel (Ni), copper (Cu), silver (Ag), palladium (Pd), or an alloy including any of these metals may be used. A ceramic component defining and functioning as a co-material may be added to the conductive paste. As the ceramic component, the main component raw material of the dielectric ceramic layer can be used. The conductive paste may be applied with a known method such as, for example, screen printing or gravure printing.

### Lamination Process

In the lamination process, green sheets are laminated and pressure bonded to obtain a multilayer block. As the green sheets, green sheets on which an inner electrode pattern is formed are used, but a green sheet on which no inner electrode pattern is formed may partially be used. The lamination and the pressure bonding may be performed with a known method.

### Cutting Process

In the cutting process, the obtained multilayer block is cut to obtain a multilayer chip. The cutting may be performed so that a multilayer chip having a predetermined size is obtained and at least a portion of the inner electrode pattern is exposed to the end surface of the multilayer chip.

### Firing Process

In the firing process, the obtained multilayer chip is subjected to a binder removal treatment and a firing treatment to obtain an element body. The green sheet and the inner electrode pattern are co-sintered by the firing treatment to form a dielectric ceramic layer an and inner electrode layer, respectively. The conditions of the binder removal treatment may be determined depending on the type of the organic binder included in the green sheet and the inner electrode pattern. The firing treatment may be performed at a temperature at which the multilayer chip is sufficiently densified. For example, the firing treatment may be performed with a condition that a temperature of about 1100° C. or more and about 1200° C. or less is maintained for about 1 hour or more and about 10 hours or less. The firing is performed in an atmosphere in which the BaTiO₃ based compound being the main component is not reduced and the oxidation of the conductive metal is mitigated. For example, the firing may be performed in an N₂—H₂—H₂O gas flow having an oxygen partial pressure of about 1.9×10⁻¹¹ MPa or more and about 6.4×10⁻⁹ MPa or less. Further, an annealing treatment may be performed after the firing.

### Outer Electrode Forming Process

In the outer electrode forming process, the outer electrodes are formed on the obtained element body. The outer electrodes may be formed with a known method. For example, the outer electrodes may be formed such that the conductive paste including a metal such as silver (Ag), copper (Cu), and/or nickel (Ni) is applied to the end surfaces of the element body to which the inner electrode layers are extended to be exposed and is baked. Alternatively, the outer electrodes may be formed with a method in which the conductive paste is applied to both end surfaces of the multilayer chip before firing and then the multilayer chip is subjected to the firing treatment. The formed electrode may be used as a base layer, and a plating film of, for example, nickel (Ni), tin (Sn), or the like may be formed thereon. Thus, a multilayer ceramic capacitor is fabricated.

### EXAMPLES

Example embodiments of the present invention will be described in more detail with reference to the following Examples and Comparative Examples. However, the present invention is not limited to the following Examples.

### (1) Fabrication of Multilayer Ceramic Capacitor

### Examples 1 to 19

Samples of the multilayer ceramic capacitor were fabricated through the following procedure.

First, a BaTiO₃ powder having a BET size of, for example 190 nm and tetragonality of, for example 1.0099 was prepared as a BT-A powder. Here, the tetragonality is an index of a degree as a tetragonal crystal in the tetragonal crystal structure and is represented by a ratio of a c-axis length to an a-axis length (c/a axis ratio) in the tetragonal crystal. The tetragonality can be determined by, for example, a powder X-ray diffraction (XRD) method. The BET size is a mean primary particle size determined by converting the BET specific surface area of the BaTiO₃ powder, assuming that the particle is spherical.

In addition to the above, a BaTiO₃ powder having a BET size of, for example 100 nm and the tetragonality of, for example 1.007 was prepared as a BT-B powder, and the BT-B powder was wet-pulverized to obtain a finely pulverized BT-B powder. The BET specific surface area of the finely pulverized BT-B powder was 50 m²/g.

Further, a Dy₂O₃ powder, a BaCO₃ powder, and a TiO₂ powder were individually wet-pulverized to obtain a finely pulverized Dy₂O₃ powder, a finely pulverized BaCO₃ powder, and a finely pulverized TiO₂ powder. The BET specific surface area of each of the finely pulverized Dy₂O₃ powder, the finely pulverized BaCO₃ powder, and the finely pulverized TiO₂ powder was within a range of about 50 m²/g to about 56 m²/g.

Next, the BT-A powder, the finely pulverized BT-B powder, the finely pulverized Dy₂O₃ powder, the finely pulverized BaCO₃ powder, and the finely pulverized TiO₂ powder were mixed using a wet mill so as to obtain the compositions shown in Table 1 below, and dried to obtain a mixed powder. Table 1 also shows an A/B ratio, which is a molar ratio of the A-site element to the B-site element in the perovskite oxide (ABO₃). Dy was treated as being included in both the A-site and the B-site in terms of the formulation composition so that the A/B ratio shown in Table 1 was obtained.

The obtained mixed powder was subjected to a heat treatment in which the temperature was raised to about 1100° C. with a temperature raising rate of about 600° C./hour in the air and was held for about 2 hours after that, thus obtaining a calcined powder.

Relative to TiO₂ of 100 molar parts in the calcined powder, an MgCO₃ powder of about 1.0 molar part, an MnCO₃ powder of about 0.3 molar parts, and SiO₂ sol and Li₂CO₃ in amounts shown in Table 1 below were added to the calcined powder, and the mixture was wet-mixed and dried to obtain a dielectric powder.

A polybutyral based binder and a plasticizer were added to the obtained dielectric powder, toluene and ethyl alcohol were further added to make slurry using a wet mill, and the slurry was molded to obtain a green sheet. The obtained green sheet had a thickness of about 1.7 μm after being sintered and densified.

A surface of the obtained green sheet was screen-printed with a conductive paste including nickel as a main component to form a pattern of a conductive paste layer that is to be an inner electrode layer.

Thereafter, 201 green sheets each including a conductive paste layer formed on the surface thereof were laminated such that the sides, of the green sheets, having the extended conductive paste layers were alternated one by one, green sheet layers including no conductive paste layer formed thereon were provided on top and bottom, and the whole green sheets were pressure bonded to fabricate a multilayer block.

The obtained multilayer block was cut into green multilayer chips. The cutting was performed such that the size of the manufactured multilayer ceramic capacitor was about 3.2 mm×about 1.6 mm.

The obtained green multilayer chip was heat-treated at about 280° C. in an N₂ air stream to burn and remove the binder. Subsequently, the green multilayer chip was fired for about 2 hours in an N₂—H₂—H₂O gas flow under conditions of about 1150° C. and an oxygen partial pressure of about 1.6×10⁻⁹ MPa.

In the fired multilayer chip, a conductive paste including Cu as a main component was applied to an end surface portion to which the inner electrode layers were extended, the conductive paste was baked at about 800° C. to form the outer electrode, and further, an Ni—Sn plating layer was formed on the surface of the outer electrode.

As described above, a multilayer ceramic capacitor was fabricated. The obtained multilayer ceramic capacitor had outer dimensions of about 3.2 mm in length×about 1.6 mm in width×about 1.6 mm in thickness. The number of dielectric ceramic layers sandwiched by the inner electrode layers was 200, and the thickness of each dielectric ceramic layer was about 1.7 μm.

### Examples 20 to 23

Rare-earth oxides (Gd₂O₃, Y₂O₃, Ho₂O₃, and Er₂O₃) corresponding to the rare-earth element (Re) type shown in Table 1 below were prepared. These rare-earth oxides were individually wet-pulverized until the BET specific surface area fell within a range of about 50 m²/g to about 60 m²/g, to obtain a finely pulverized Re-oxide powder. The raw material powders (BT-A powder, finely pulverized BT-B powder, finely pulverized Re-oxide powder, finely pulverized BaCO₃ powder, and finely pulverized TiO₂ powder) were mixed and dried so as to obtain compositions shown in Table 1 below, thus obtaining a mixed powder. In terms of the formulation composition, the rare-earth element (Re) was treated as being included in both the A-site and the B-site, and the raw materials were formulated so as to obtain the A/B ratio shown in Table 1 below. Other than that, the multilayer ceramic capacitor was fabricated in the same manner as in Examples 1 to 19.

### Examples 24 to 28

Rare-earth oxides (Dy₂O₃, La₂O₃, Nd₂O₃, Tb₄O₇, Yb₂O₃, Lu₂O₃, Eu₂O₃, Sm₂O₃, CeO₂, Pr₆O₁₁, and Tm₂O₃) corresponding to the rare-earth element (Re) type shown in Table 1 below were prepared. These rare-earth oxides were individually wet-pulverized until the BET specific surface area fell within a range of about 50 m²/g to about 60 m²/g, to obtain a finely pulverized Re-oxide powder. The raw material powders (BT-A powder, finely pulverized BT-B powder, finely pulverized Re-oxide powder, finely pulverized BaCO₃ powder, and finely pulverized TiO₂ powder) were mixed and dried so as to obtain the compositions shown in Table 1 below, thus obtaining a mixed powder. In the formulation of the raw materials, the adding amount of the rare-earth element other than Dy was about 0.1 molar parts in all cases. La, Nd, Eu, Sm, Ce, and Pr were treated as being in the A-site in terms of the formulation composition. Tb, Yb, Lu, and Tm were treated as being in the B-site in terms of the formulation composition. Dy was treated as being included in both the A-site and the B-site in terms of the formulation composition. In consideration of the above, the raw materials were formulated so as to obtain the A/B ratio shown in Table 1 below. Other than that, the multilayer ceramic capacitor was fabricated in the same manner as in Examples 1 to 19.

### (2) Evaluation

The multilayer ceramic capacitors obtained in Examples 1 to 28 were evaluated for various characteristics as follows.

### TEM Observation/EDX Analysis

The dielectric ceramic layer of the multilayer ceramic capacitor was observed under a field emission transmission electron microscope (FE-TEM), and the component analysis of a fine region was performed using an energy dispersive X-ray spectrometer (EDX) attached to the TEM. The observation sample was fabricated by slicing the dielectric ceramic layer by a FIB lift-out method. The observation and analysis were performed under the following conditions.
Apparatus: JEM-2200FS/Noran System 7 manufactured by JEOL Ltd.
Field of view: n=2
Magnification: about 60000 times
Pixel size: about 9.2 nm/1 pixel
Spot diameter: about 1 nm φ
Measurement: EDX integration number 100 times

During the observation, the dielectric ceramic layer in the observation field of view was spotted, a region of an Re/Ti ratio of about 0.04 or more and about 0.30 or less was defined as the rare-earth high-concentration region, and the area ratio thereof was calculated with the following Equation (5). Further, the Re/Ti ratio of each pixel in the rare-earth high-concentration region was measured, and the CV value was calculated with the following Equation (1) using the mean value and the standard deviation σ of the Re/Ti ratios.

$$( 5 )$$

$$Rare earth high - concentration region area rate ( \% ) = \frac{\begin{matrix}( Number of pixels of rare earth \\ high - concentration region )\end{matrix}}{\begin{matrix}( Number of pixels of dielectric \\ ceramic layer )\end{matrix}} \times 100$$

$$CV value of Re / Ti ratio ( \% ) = \frac{( σ of Re / Ti ratio )}{( Mean value of Re / Ti ratio )} \times 100 \qquad ( 1 )$$

The CV value of the thickness direction line segment ratio of the rare-earth high-concentration region was obtained as follows. First, in a section including the thickness direction, one virtual line parallel or substantially parallel to the thickness direction was drawn. Next, the number of pixels of the dielectric ceramic layer on the line was obtained as a value corresponding to L_{C} that is the length of a portion through which the line crosses the dielectric ceramic layer. The number of pixels of the rare-earth high-concentration region on the line was obtained as a value corresponding to L_{high-Re} that is the total length of portions through which the line crosses the rare-earth high-concentration region. As described in the following Equation (6), the ratio of L_{high-Re} to L_{C} (L_{high-Re}/L_{C}) was calculated as the thickness direction line segment ratio of the rare-earth high-concentration region. The thickness direction line segment ratio was calculated for 256 lines spaced apart, and the CV value was obtained with the following Equation (2) using the mean value and the standard deviation σ of the thickness direction line segment ratios.

$$\begin{matrix}\begin{matrix}Thickness direction line segment ratio of rare \\ earth high - concentration region ( \% )\end{matrix} = \frac{{L}_{high - Re}}{{L}_{c}} \times 100 \\ = \frac{\begin{matrix}( Number of pixels of rare earth \\ high - concentration region on line )\end{matrix}}{\begin{matrix}( Number of pixels of dielectric \\ ceramic layer on line )\end{matrix}} \times 100\end{matrix} \qquad ( 6 )$$

$$\begin{matrix}CV value of thickness \\ direction line segment ratio ( \% )\end{matrix} = \frac{\begin{matrix}( σ of thickness direction \\ line segment ratio )\end{matrix}}{\begin{matrix}( Mean value of thickness \\ direction line segment ratio )\end{matrix}} \times 100 \qquad ( 2 )$$

Further, a region where the Re/Ti ratio was less than about 0.04 was defined as a rare-earth low-concentration region, and the equivalent circle diameter and the circularity of the sub-region constituting the rare-earth low-concentration region were obtained. Specifically, a boundary between the sub-region constituting the rare-earth low-concentration region and the rare-earth high-concentration region was drawn with a touch pen. The obtained data were analyzed using image analysis software (WINROOF, Mitani Corporation) to determine an area and a perimeter of each sub-region. Further, the total area of the sub-regions was defined as 100 (100%), and the areas of the sub-regions were integrated in ascending order. The area of the sub-region when the cumulative value reached 50 (about 50%) (cumulative 50% area) was obtained. The mean equivalent circle diameter (D50) was calculated with the following Equation (3) using the cumulative 50% area above. The circularity of each sub-region was determined with the following Equation (4), and the mean value thereof was calculated.

$$Average equivalent circle diameter = \sqrt{\frac{4}{π} \cdot ( Cumulative 50 \% area )} \qquad ( 3 )$$

$$Circularity = \frac{4 π \times ( Area of each sub - region )}{{( Perimeter of each sub - region )}^{2}} \qquad ( 4 )$$

### Dielectric Properties

The electrostatic capacitance (C) of the obtained multilayer ceramic capacitor was measured under conditions of AC voltage about 1 V and about 1 kHz using an automatic bridge measuring device. The relative dielectric constant (εᵣ) was calculated using the area of the facing electrodes in the multilayer ceramic capacitor, the number of the dielectric ceramic layers, and the thickness of the dielectric ceramic layer. The measurement was performed on 72 samples fabricated under the same or substantially the same condition, and the mean value of the obtained values was calculated.

### Reliability (MTTF, B1 Life)

The multilayer ceramic capacitors were subjected to a highly accelerated lifetime test (HALT) to determine the mean time to failure (MTTF). In the highly accelerated lifetime test, a high temperature load was applied to the sample under conditions of a temperature of about 175° C. and a test voltage of about 50 V. The time when the insulation resistance became about 200 kΩ or less was defined as time to failure. The time to failure was measured for 72 samples fabricated under the same or substantially the same conditions.

Next, the obtained data were plotted on Weibull probability sheet to determine the Weibull distribution. In the obtained Weibull distribution, the relationship between the time to failure and the cumulative failure rate was subjected to linear regression, and the slope was obtained as a shape parameter m. Further, time to failure at which the cumulative failure rate was about 63.2% was read, and the mean time to failure (MTTF) at the test voltage about 50 V was determined using this time to failure and the shape parameter m corresponding to the slope of the regression line. Samples having MTTF of about 50 hours or more were determined to be acceptable. The time to failure at which the cumulative failure rate was about 1% was defined as the B1 life. The B1 life/MTTF was calculated in % representation.

Further, the highly accelerated lifetime test was performed under the same or substantially the same condition except that the test voltage was changed to about 60 V to determine the mean time to failure (MTTF) at the test voltage about 60 V, and a decrease in MTTF was calculated with the following Equation (7).

$$Decrease in MTTF ( \% ) = \frac{( MTTF with test voltage 60 V )}{( MTTF with test voltage 50 V )} \times 100 \qquad ( 7 )$$

### (3) Evaluation Results

The evaluation results obtained for Examples 1 to 28 are collectively shown in Table 1 below. A value in “MTTF” shown in Table 1 is a value measured under the condition of the test voltage about 50 V except for a value in “Decrease in MTTF”.

In the samples of Examples in which the area ratio of the rare-earth high-concentration region was about 50% or more (Examples 2 to 17, and 19 to 28), MTTF was about 71 hours or more. In particular, in the samples in which the rare-earth element (Re) was Dy and the area ratio was about 60% or more (Examples 9, 12, 14, and 16), MTTF was about 122 hours or more which was long. On the other hand, in the samples of Comparative Examples having an area ratio of less than about 50% (Examples 1 and 18), MTTF was about 39 hours or less, which was short. From the results above, it was discovered that a highly reliable multilayer ceramic capacitor can be obtained by increasing the area ratio of the rare-earth high-concentration region to about 50% or more.

In all of the samples of Examples (Examples 2 to 17, and 19 to 28), the CV value of the thickness direction line segment ratio of the rare-earth high-concentration region was about 25% or less. In particular, in the samples in which the CV value of the thickness direction line segment ratio was about 15% or less (Examples 2 to 17, and 20 to 28), MTTF was about 79 hours or more, and the B1 life/MTTF was about 23% or more. From the results above, it was discovered that the reliability and the variation thereof can be mitigated by reducing the CV value of the thickness direction line segment ratio of the rare-earth high-concentration region.

The samples of Examples in which the CV value of the Re/Ti ratio was about 35% or less (Examples 2 to 14, 16, 17, and 19 to 28) had the B1 life/MTTF of about 19% or more, and the variation in the time to failure was small. In particular, the samples of Examples in which the CV value of the Re/Ti ratio was about 15% or less (Examples 11, 14, and 17) had the B1 life/MTTF of about 47% or more, and the variation in the time to failure was very small.

The samples of Examples of the equivalent circle diameter of about 130 nm or more in the rare-earth low-concentration region (Examples 2 to 11, 13 to 17, and 19 to 28) had a relative dielectric constant εᵣ of about 2600 or more. Further, the samples of Examples of the circularity of about 0.70 or more in the rare-earth low-concentration region (Examples 2 to 12, 14 to 17, and 19 to 28) had a decrease in MTTF of about 58% or less. From the results above, it was discovered that the variation and the voltage dependency in reliability can be mitigated and the dielectric constant can be increased by setting the CV value of the Re/Ti ratio and the equivalent circle diameter and/or the circularity in the rare-earth low-concentration region within predetermined ranges.

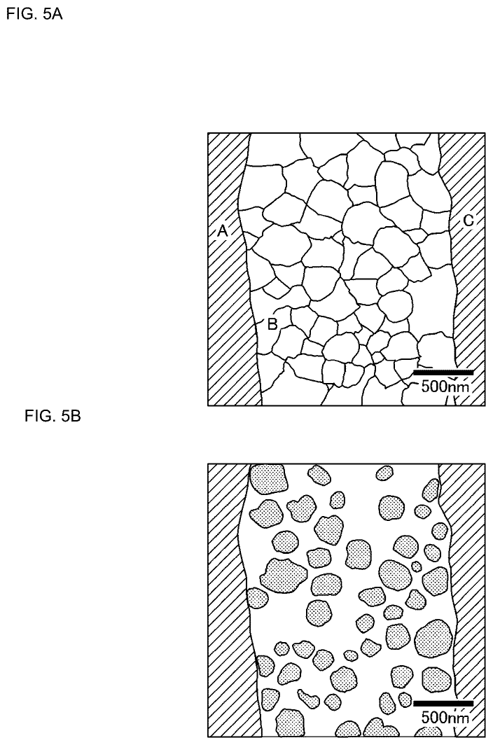

A microstructure and an element distribution in a section of the multilayer ceramic capacitor obtained in Examples are schematically illustrated in FIGS. 5A and 5B. FIG. 5A is a view illustrating a sectional microstructure, and in the drawing, points A and C each indicate an inner electrode layer, and a point B indicates a dielectric ceramic layer. FIG. 5B is an element distribution diagram illustrating a Dy distribution. In FIG. 5B, the region having a high Dy concentration in the dielectric ceramic layer is depicted in a bright tone, and the region having a low Dy concentration is depicted in a dark tone. As illustrated in FIG. 5A, the dielectric ceramic layer is composed of a large number of crystal grains. As illustrated in FIG. 5B, the Dy distribution is uneven, and Dy low-concentration regions are distributed in an island shape in Dy high-concentration regions. Further, crystal grains including multiple independent rare-earth low-concentration regions are present.

TABLE 1
Manufacturing Condition, Microstructure, and Characteristics of Multilayer Ceramic Capacitor

| | Mixture composition of dielectric ceramic layer | | | | | | | | |
|---|---|---|---|---|---|---|---|---|---|
| | BT-A | BT-B | | Re | SiO₂ | Li₂O | BaCO₃ | TiO₂ | |
| | (Molar parts) | (Molar parts) | Re type | (Molar parts) | (Molar parts) | (Molar parts) | (Molar parts) | (Molar parts) | A/B |
| Example 1* | 81.50 | 15.00 | Dy | 3.5 | 1.0 | 0.0 | 1.2 | 3.5 | 1.012 |
| Example 2 | 75.80 | 20.00 | Dy | 6.0 | 1.0 | 1.5 | 1.2 | 2.4 | 1.012 |
| Example 3 | 70.10 | 25.00 | Dy | 7.0 | 1.0 | 1.5 | 1.2 | 2.8 | 1.012 |
| Example 4 | 70.10 | 25.00 | Dy | 7.0 | 1.0 | 1.5 | 1.2 | 2.8 | 1.012 |
| Example 5 | 75.80 | 20.00 | Dy | 6.0 | 1.0 | 1.5 | 1.2 | 2.4 | 1.012 |
| Example 6 | 76.15 | 20.00 | Dy | 5.5 | 1.0 | 1.5 | 1.2 | 2.2 | 1.012 |
| Example 7 | 70.80 | 25.00 | Dy | 6.0 | 1.0 | 1.5 | 1.2 | 2.4 | 1.012 |
| Example 8 | 64.75 | 30.00 | Dy | 7.5 | 1.0 | 1.5 | 1.2 | 3.0 | 1.012 |
| Example 9 | 60.80 | 35.00 | Dy | 6.0 | 1.0 | 1.5 | 1.2 | 2.4 | 1.012 |
| Example 10 | 75.45 | 20.00 | Dy | 6.5 | 1.0 | 1.5 | 1.2 | 2.6 | 1.012 |
| Example 11 | 70.10 | 25.00 | Dy | 7.0 | 4.0 | 4.5 | 1.2 | 2.8 | 1.012 |
| Example 12 | 75.80 | 20.00 | Dy | 6.0 | 1.0 | 1.5 | 1.2 | 2.4 | 1.012 |
| Example 13 | 71.15 | 25.00 | Dy | 5.5 | 1.0 | 1.5 | 1.2 | 2.2 | 1.012 |
| Example 14 | 65.80 | 30.00 | Dy | 6.0 | 4.0 | 4.5 | 1.2 | 2.4 | 1.012 |
| Example 15 | 63.60 | 30.00 | Dy | 8.0 | 1.0 | 1.5 | 1.2 | 4.8 | 1.012 |
| Example 16 | 55.45 | 40.00 | Dy | 6.5 | 2.0 | 2.5 | 1.2 | 2.6 | 1.012 |
| Example 17 | 75.45 | 20.00 | Dy | 6.5 | 4.0 | 4.5 | 1.2 | 2.6 | 1.012 |
| Example 18* | 70.80 | 25.00 | Dy | 6.0 | 4.0 | 4.5 | 1.2 | 2.4 | 1.012 |
| Example 19 | 63.60 | 30.00 | Dy | 8.0 | 1.0 | 1.5 | 1.2 | 4.8 | 1.012 |
| Example 20 | 70.80 | 25.00 | Gd | 6.0 | 1.0 | 1.5 | 1.2 | 2.4 | 1.012 |
| Example 21 | 56.15 | 40.00 | Y | 5.5 | 1.0 | 1.5 | 1.2 | 2.2 | 1.012 |
| Example 22 | 65.80 | 30.00 | Ho | 6.0 | 1.0 | 1.5 | 1.2 | 2.4 | 1.012 |
| Example 23 | 60.80 | 35.00 | Er | 6.0 | 1.0 | 1.5 | 1.2 | 2.4 | 1.012 |
| Example 24 | 69.40 | 25.00 | Dy-La | 7.0 | 1.0 | 1.5 | 1.2 | 4.2 | 1.012 |
| Example 25 | 70.45 | 25.00 | Dy-Tb-Nd | 6.5 | 1.0 | 1.5 | 1.2 | 2.6 | 1.012 |
| Example 26 | 66.50 | 30.00 | Dy-Yb-Lu | 7.0 | 1.0 | 1.5 | 1.2 | 0.0 | 1.012 |
| Example 27 | 65.45 | 30.00 | Dy-Eu-Sm | 6.5 | 1.0 | 1.5 | 1.2 | 2.6 | 1.012 |
| Example 28 | 74.40 | 20.00 | Dy-Ce-Pr-Tm | 7.0 | 1.0 | 1.5 | 1.2 | 4.2 | 1.012 |

| | Microstructure | | | | | | | | |
|---|---|---|---|---|---|---|---|---|---|
| | Rare earth high- | | | | | | | | |
| | concentration region | | | Rare earth low- | | | | | |
| | | | CV | concentration region | | Characteristics | | | |
| | | CV value | value | Equivalent | | Relative | | | B1 |
| | Area | of line | of | circle | | dielectric | | Decrease | life/ |
| | ratio | segment | Re/Ti | diameter | | constant | MTTF | in MTTF | MTTF |
| | (%) | ratio (%) | (%) | (nm) | Circularity | εr | (hr) | (%) | (%) |
| Example 1* | 40 | 30 | 42.9 | 203 | 0.89 | 4000 | 39 | 50 | 27 |
| Example 2 | 56 | 14 | 25.0 | 205 | 0.81 | 3000 | 102 | 54 | 40 |
| Example 3 | 55 | 13 | 25.2 | 199 | 0.83 | 2800 | 144 | 52 | 38 |
| Example 4 | 57 | 12 | 27.4 | 165 | 0.80 | 3000 | 150 | 50 | 33 |
| Example 5 | 51 | 14 | 34.0 | 210 | 0.86 | 3600 | 145 | 58 | 31 |
| Example 6 | 54 | 11 | 26.1 | 189 | 0.80 | 3700 | 120 | 58 | 39 |
| Example 7 | 58 | 12 | 23.0 | 164 | 0.85 | 3500 | 126 | 57 | 37 |
| Example 8 | 59 | 10 | 28.0 | 158 | 0.79 | 3000 | 154 | 50 | 40 |
| Example 9 | 67 | 7 | 24.7 | 142 | 0.74 | 2800 | 122 | 53 | 43 |
| Example 10 | 55 | 11 | 31.2 | 160 | 0.83 | 3000 | 131 | 56 | 36 |
| Example 11 | 52 | 8 | 14.5 | 188 | 0.83 | 2900 | 161 | 52 | 47 |
| Example 12 | 69 | 7 | 31.2 | 118 | 0.77 | 2300 | 128 | 57 | 41 |
| Example 13 | 58 | 12 | 22.3 | 183 | 0.66 | 2700 | 171 | 70 | 45 |
| Example 14 | 72 | 4 | 9.0 | 153 | 0.87 | 3000 | 204 | 51 | 60 |
| Example 15 | 55 | 13 | 39.0 | 182 | 0.88 | 3500 | 79 | 50 | 23 |
| Example 16 | 60 | 8 | 18.7 | 195 | 0.87 | 3700 | 190 | 51 | 49 |
| Example 17 | 57 | 7 | 13.0 | 188 | 0.81 | 3600 | 188 | 53 | 54 |
| Example 18* | 42 | 14 | 14.9 | 203 | 0.89 | 2700 | 35 | 50 | 47 |
| Example 19 | 51 | 22 | 34.6 | 183 | 0.88 | 3500 | 71 | 50 | 19 |
| Example 20 | 66 | 8 | 23.7 | 180 | 0.82 | 2900 | 153 | 51 | 37 |
| Example 21 | 77 | 8 | 26.7 | 155 | 0.70 | 2600 | 99 | 58 | 35 |
| Example 22 | 69 | 9 | 28.5 | 174 | 0.83 | 3100 | 105 | 55 | 43 |
| Example 23 | 75 | 5 | 20.1 | 162 | 0.82 | 2800 | 150 | 54 | 30 |
| Example 24 | 64 | 8 | 23.4 | 168 | 0.80 | 3100 | 87 | 57 | 39 |
| Example 25 | 57 | 14 | 27.9 | 183 | 0.80 | 3300 | 178 | 56 | 37 |
| Example 26 | 73 | 7 | 23.2 | 191 | 0.83 | 3500 | 140 | 55 | 34 |
| Example 27 | 65 | 9 | 25.4 | 178 | 0.78 | 3200 | 90 | 56 | 31 |
| Example 28 | 59 | 10 | 34.1 | 175 | 0.79 | 2800 | 87 | 54 | 33 |

Notice 1)
*indicates Comparative Example
Notice 2)
“A/B” indicates a molar ratio of A-site element to B-site element in perovskite oxide (ABO₃)

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a first main surface and a second main surface opposed to each other in a thickness direction, a first side surface and a second side surface opposed to each other in a width direction, and a first end surface and a second end surface opposed to each other in a length direction;
an element body including dielectric ceramic layers and inner electrode layers laminated in the thickness direction; and
a pair of outer electrodes on the first end surface and the second end surface and electrically connected to the inner electrode layers; wherein
the dielectric ceramic layers include as a main component a crystal grain including perovskite composite oxide including barium (Ba) and titanium (Ti) and further including a rare-earth element (Re);
the dielectric ceramic layers include, in a section including the thickness direction, a rare-earth high-concentration region with an area ratio of about 50% or more having a molar ratio of the rare-earth element (Re) to titanium (Ti) (Re/Ti ratio) of about 0.04 or more and about 0.30 or less; and
in the section, a CV value of a thickness direction line segment ratio of the rare-earth high-concentration region is about 25% or less.

2. The multilayer ceramic capacitor according to claim 1, wherein, in the section, the CV value of the thickness direction line segment ratio of the rare-earth high-concentration region is about 15% or less.

3. The multilayer ceramic capacitor according to claim 1, wherein, in the section, the dielectric ceramic layers include the rare-earth high-concentration region of the area ratio of about 60% or more.

4. The multilayer ceramic capacitor according to claim 1, wherein, in the section, a CV value of the Re/Ti ratio in the rare-earth high-concentration region is about 35% or less.

5. The multilayer ceramic capacitor according to claim 1, wherein, in the section, a CV value of the Re/Ti ratio in the rare-earth high-concentration region is about 15% or less.

6. The multilayer ceramic capacitor according to claim 1, wherein
in the section, the dielectric ceramic layers include a rare-earth low-concentration region with a ratio of the rare-earth element (Re) to titanium (Ti) (Re/Ti ratio) being less than about 0.04;
the rare-earth low-concentration region includes sub-regions surrounded by the rare-earth high-concentration region; and
a mean value of equivalent circle diameters of the respective sub-regions in the section is about 130 nm or more.

7. The multilayer ceramic capacitor according to claim 6, wherein a mean value of circularities of the respective sub-regions in the section is about 0.70 or more.

8. The multilayer ceramic capacitor according to claim 1, wherein
a dimension of the multilayer ceramic capacitor in the length direction is about 0.4 mm or more and about 5.7 mm or less;
a dimension of the multilayer ceramic capacitor in the width direction is about 0.2 mm or more and about 5.0 mm or less; and
a dimension of the multilayer ceramic capacitor in the thickness direction is about 0.125 mm or more and about 5.0 mm or less.

9. The multilayer ceramic capacitor according to claim 1, wherein a content of the main component of the dielectric ceramic layers is about 50 mass % or more, about 60 mass % or more, about 70 mass % or more, about 80 mass % or more, or about 90 mass % or more.

10. The multilayer ceramic capacitor according to claim 1, wherein a content of the main component of the dielectric ceramic layers is about 60 mass % or more.

11. The multilayer ceramic capacitor according to claim 1, wherein a content of the main component of the dielectric ceramic layers is about 70 mass % or more.

12. The multilayer ceramic capacitor according to claim 1, wherein a content of the main component of the dielectric ceramic layers is about 80 mass % or more.

13. The multilayer ceramic capacitor according to claim 1, wherein a content of the main component of the dielectric ceramic layers is about 90 mass % or more.

14. The multilayer ceramic capacitor according to claim 1, wherein the rare-earth element includes at least one of yttrium, lanthanum, cerium, praseodymium, neodymium, samarium, europium, gadolinium, terbium, dysprosium, holmium, erbium, thulium, ytterbium, or lutetium.

15. The multilayer ceramic capacitor according to claim 1, wherein the rare-earth element includes dysprosium.

16. The multilayer ceramic capacitor according to claim 1, wherein the dielectric ceramic layers include, in proportion to titanium of 100 mol, the rare-earth element of about 0.1 mol or more and about 35.0 mol or less.

17. The multilayer ceramic capacitor according to claim 1, wherein the dielectric ceramic layers include, in proportion to titanium of 100 mol, the rare-earth element of about 0.5 mol or more and about 30.0 mol or less.

18. The multilayer ceramic capacitor according to claim 1, wherein the dielectric ceramic layers include, in proportion to titanium of 100 mol, the rare-earth element of about 3.5 mol or more and about 25.0 mol or less.

19. The multilayer ceramic capacitor according to claim 1, wherein each of the dielectric ceramic layers has a thickness of about 0.5 μm or more and about 7.0 μm or less.

20. The multilayer ceramic capacitor according to claim 1, wherein a number of the dielectric ceramic layers is 50 or more and 1000 or less.
